(19) United States
(12) Patent Application Publication
(10) Pub. No.: US 2011/0197133 A1
(43) Pub. Date: Aug. 11, 2011

(54) METHODS AND APPARATUSES FOR IDENTIFYING AND MONITORING INFORMATION IN ELECTRONIC DOCUMENTS OVER A NETWORK

(75) Inventors: Paul Tarjan, San Jose, CA (US); Yury Lifshits, San Francisco, CA (US)

(73) Assignee: Yahoo! Inc., Sunnyvale, CA (US)

(21) Appl. No.: 12/703,982

(22) Filed: Feb. 11, 2010

(51) Int. Cl. G06F 15/177; G06F 3/00

(52) U.S. Cl. 715/736; 715/760

(57) ABSTRACT

Exemplary methods and apparatuses are provided which may be implemented using one or more computing devices to allow for certain information within an electronic document to be easily identified and monitored in an efficient manner.

### BACKGROUND

1. Field

The subject matter disclosed herein relates to data processing.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided which allow for the copious amounts of information to be searched through in an efficient manner. For example, service providers may allow for users to search the World Wide Web or other like networks using search engines. Similar tools or services may allow for one or more databases or other like data repositories to be searched.

With so much information being available and often changing over time, there is a continuing need for methods and apparatuses that allow for certain information to be easily identified and monitored in an efficient manner.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an example implementation of a networked computing environment having one or more computing devices operatively enabled to identify and monitor information in one or more electronic documents, in accordance with certain example implementations.

FIG. 2 is a schematic block diagram illustrating certain features of an example computing device that may be operatively enabled to identify and/or monitor information in one or more electronic documents, in accordance with certain example implementations.

FIG. 3 is a flow diagram illustrating a process implementable in a first computing device operatively enabled to support identification and monitoring of information in one or more electronic documents, in accordance with certain example implementations.

FIG. 4 is a flow diagram illustrating a process implementable in a second computing device operatively enabled to support identification and monitoring of information in one or more electronic documents, in accordance with certain example implementations.

### DETAILED DESCRIPTION

Some exemplary methods and apparatuses are described herein that that allow for certain information within an electronic document to be easily identified and monitored in an efficient manner.

In accordance with certain aspects, techniques are described herein which may be implemented using various methods and/or apparatuses to identify information within an electronic document to the monitored. As used herein, the identified information to be monitored is referred to as “tracked information”.

Tracked information may, for example, include information that is visually presented when an electronic document is rendered for viewing by a user of a computing device. By way of initial example but not limitation, certain tracked information may include numerical information that may change over time.

It can be difficult and/or time consuming, however, for a user to access an electronic document such as a web page over time to monitor certain tracked information. For example, it might be useful for a user to monitor a price of an item that is for sale through a retail website. Here, for example, a user may access the webpage each day and check on the latest price.

Some websites may provide a built-in price monitoring service that, for example, alerts a user via electronic mail or text message when a price change occurs in some particular manner. Unfortunately, not all websites provide such services and those that do tend to limit the amount and/or type of information that may be monitored (e.g., a website owner tends to control the information that a built-in service may monitor). Here, for example, a retail website may provide a built-in price monitoring service that allows a user to monitor a price of an item but would usually not provide a user to monitor a listed phone number, address, and/or other like information that may be presented elsewhere within the electronic document.

There are other websites which, for example, provide price monitoring services by gathering prices for a given item from a plurality of retail or other like websites. For example, some websites provide comparison shopping services by crawling websites not unlike a search engine provider might do and/or by actively exchanging pricing information with certain partner or otherwise contracted businesses through other (e.g., private) electronic communications.

In accordance with certain aspects of the present description, it is recognized that a user of a computing device may find it useful to employ an automated capability that allows a user to identify tracked information in an electronic document and initiate automatic monitoring thereof. Here, for example, the user-identified tracked information may be monitored over a period of time, at certain particular times, upon occurrence of certain events, etc. Such user and/or other users may also find it beneficial to later access tracking results corresponding to the monitoring of the tracked information. Some none limiting examples are provided in subsequent sections herein.

Thus, as described in greater detail below, in accordance with certain example implementations methods and/or apparatuses may be implemented in which a first computing device (e.g., a server or other like device) communicates with the user's computing device (“second computing device”) to obtain a tracking identifier. A tracking identifier may be specified by the second computing device based, at least in part, on user input(s). For example, a tracking identifier may be associated with tracked information as selected by a user viewing a visual presentation of an initial electronic document associated with a specified network address (e.g., a URL, etc.).

By way of example but not limitation, a user may view an initial version of a web page or another type of electronic document and graphically or otherwise select certain information therein as “tracked information”. In certain instances, an initial electronic document may be accessed directly from a network computing resource at an initial time, or indirectly from a network computing resource through the first computing device. In certain instances, the formatting of an initial electronic document may allow such initial electronic document to be used as a “selectable version of the initial electronic document” without further modification. In other instances, all or part of the formatting of an initial electronic document may be modified in some manner to provide a selectable version of the initial electronic document. A selectable version of the initial electronic document may, for example, be used to provide a user an interactive visual presentation of the initial electronic document through a browser or other like application operating on the second computing device.

The second computing device may provide a tracking identifier that is associated with the tracked information to a first computing device, for example, over a network. The second computing device may also provide an optional tracking request, which may include additional information associated with the tracked information. For example, a tracking request may include information about the first computing device and/or user thereof, a description of the tracked information, selected monitoring information (e.g., one or more times, periods, durations, dates, events, thresholds, etc.) associated with a desired monitoring process, and/or other like information. Some none limiting examples are provided in subsequent sections herein.

A first computing device, having obtained a tracking identifier and (optional) tracking request, may monitor the tracked information at one or more times, for example, by accessing at least one subsequent electronic document associated with the electronic document identifier from a network computing resource and identifying subsequent tracked information therein based, at least in part, on the tracking identifier. The first computing device may also, for example, store data representing subsequent tracked information in memory.

In certain example implementations, a first computing device may obtain a tracking identifier and (optional) tracking request by providing a selectable version of the initial electronic document and/or an information selector to the second computing device. An information selector may, for example, include computer-implementable instructions that may enable the second computing device to establish a tracking identifier based, at least in part, on user input received via a graphical user interface (GUI) and/or the like. For example, an information selector may receive user input via a GUI in response to a display of visual information associated with a selectable version of the initial electronic document wherein a portion of the visual information presents the tracked information.

In certain example implementations, at least a portion of a selectable version of the initial electronic document may include an extensible markup language (XML) and a tracking identifier may include at least a portion of an XPath associated therewith.

A first computing device may, for example, selectively monitor tracked information at one or more times subsequent to the initial time based, at least in part, on a tracking request as specified via the second computing device. A first computing device may, for example, provide one or more tracking results based, at least in part, on at least a portion of the subsequent tracked information to the second computing device and/or one or more other computing devices. In certain example implementations, tracking results may include processed or unprocessed information. Some none limiting examples are provided in subsequent sections herein.

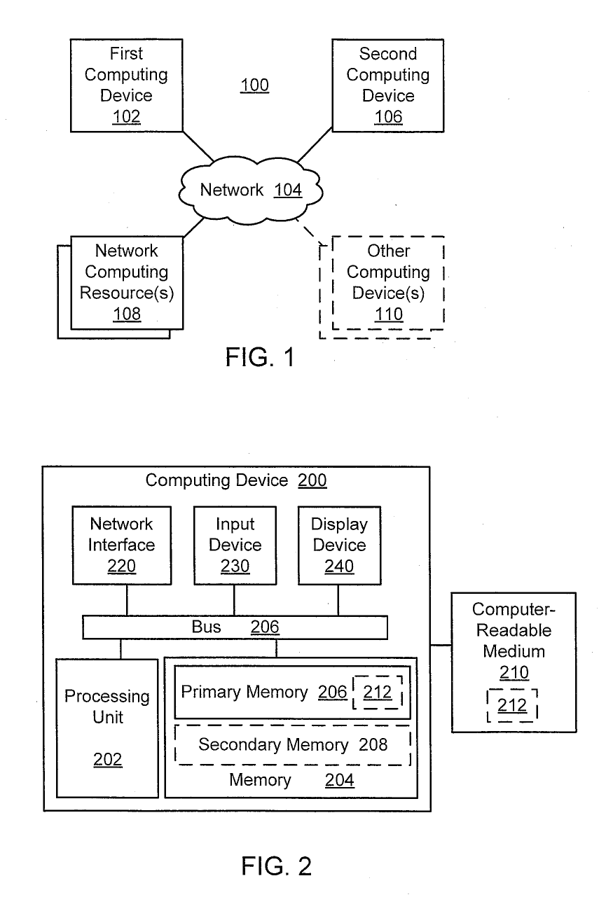

Reference is now made to FIG. 1 which illustrates an example computing environment 100 having a first computing device 102 coupled to a network 104. By way of example but not limitation, first computing device 102 may include one or more servers or other like computing devices enabled to communicate with a second computing device 106, one or more network computing devices 108, and/or other computing devices 110 through network 104.

Second computing device 106 may, for example, include a client or other like computing device through which a user may interact to access other devices and services that may be available within computing environment 100. By way of example but not limitation, second computing device 106 may include a personal computer, a workstation, a laptop computer, a net book, a personal digital assistant (PDA), a smart phone, a kiosk, and/or other like devices. In certain example implementations, second computing device may include a display device through which a graphical user interface (GUI) and/or other like application or process may be employed and information in an electronic document presented to a user for interaction. Here, for example, a browser or other like application or process may be implemented via a GUI in a manner for presenting visual information to a user, obtaining user inputs (e.g., via a keyboard, mouse, pointer, touch screen, microphone, etc.), and/or supporting communication exchanges with various devices and/or services available within computing environment 100. As described in greater detail below, in certain example implementations an information selector may be provided and operatively enabled to support and/or otherwise assist in user presentation and/or user input operations associated with a selectable version of an initial electronic document.

Network 104 may represent one or more communication networks and/or other like systems. For example, network 104 may include one or more wired and/or wireless telecommunication systems or networks, one or more local area networks or the like, an intranet, the Internet, etc. In certain example implementations, network computing resources 108 may represent one or more computing devices and/or services from which various types/forms of files and/or electronic documents may be downloaded, or conversely uploaded to. By way of example but not limitation, network computing resources may include one or more servers and/or other like computing devices which host various websites, web pages, databases, and/or other like communication and/or information related services.

Other computing devices 110 are included in example computing environment 100 for the purpose of further illustrating that one or more computing devices, perhaps similar in form to first and/or second computing devices, may also benefit from the techniques provided herein.

For the sake of brevity, the term “electronic document” as used herein is intended to broadly represent any form of information, such as, e.g., data and/or executable instructions or other like functionality, that computing devices within computing environment 100 may exchange over network 104. Thus, for example, certain “electronic documents” may comprise a web page, an executable script or other like computer executable code, a text file, a graphs file, an image file, a video file, an audio file, or the like, and/or any combination thereof. Some example electronic documents may include electronic documents associated with certain computer applications/services, such as, e.g., a browser, a word processor, a drawing application, a spreadsheet or other like application, a presentation application, etc. As is well known, such “electronic documents” may be communicated between one or more computing devices in accordance with various applicable communication techniques and protocols.

While terms such as, e.g., database, browser, application, GUI, server, and client, are used in some of the examples presented herein to illustrate certain traditional computing functionality, it should be clear that the techniques provided herein are not necessarily limited to such example implementations and/or traditional computing functionality.

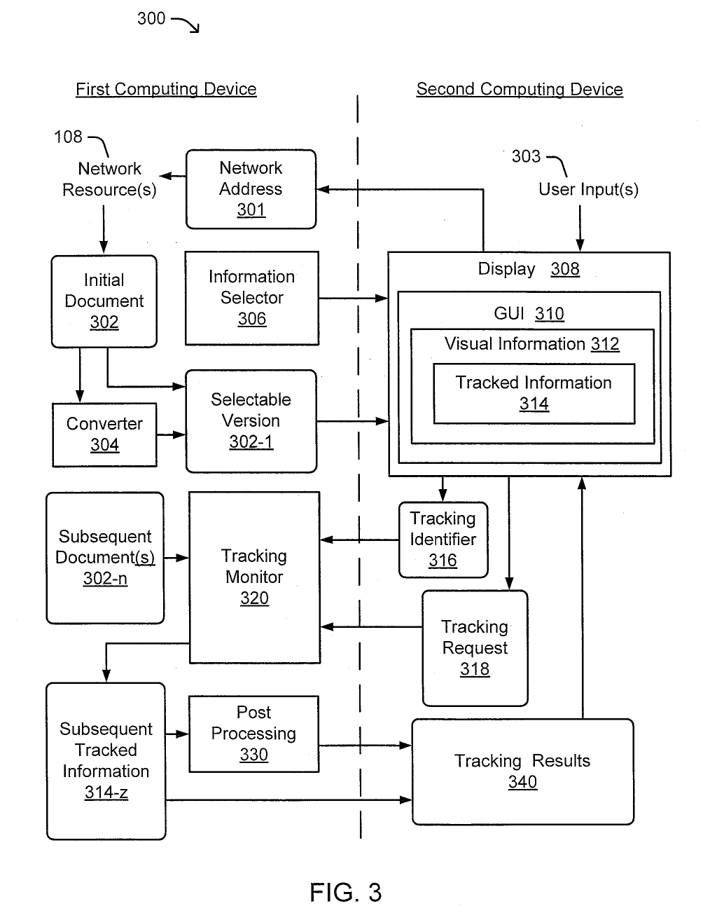

Reference is made next to FIG. 2, which shows an example computing device 200 that may take the form, at least in part, of first computing device 102, second computing device 106, network computing resources 108, and/or other computing devices 110 as illustrated in FIG. 1.

Computing device 200 may, for example, include one or more processing units 202, memory 204 and at least one bus 206.

Processing unit 202 is representative of one or more circuits configurable to perform at least a portion of a data computing procedure or process. By way of example but not limitation, processing unit 202 may include one or more processors, controllers, microprocessors, microcontrollers, application specific integrated circuits, digital signal processors, programmable logic devices, field programmable gate arrays, and the like, or any combination thereof.

Memory 204 is representative of any data storage mechanism. Memory 204 may include, for example, a primary memory 206 and/or a secondary memory 208. Primary memory 206 may include, for example, a solid state memory such as a random access memory, read only memory, etc. While illustrated in this example as being separate from processing unit 202, it should be understood that all or part of primary memory 206 may be provided within or otherwise co-located/coupled with processing unit 202.

Secondary memory 208 may include, for example, the same or similar type of memory as primary memory and/or one or more data storage devices or systems, such as, for example, a disk drive, an optical disc drive, a tape drive, a solid state memory drive, etc. In certain implementations, secondary memory 208 may be operatively receptive of, or otherwise configurable to couple to, a computer-readable medium 210. Computer-readable medium 210 may include, for example, any media that can carry and/or make accessible data, code and/or instructions 212 for use, at least in part, by processing unit 202 and/or other circuitry within computing device 200.

Computing device 200 may include, for example, a network interface 220 that provides for or otherwise supports the operative coupling of computing device 200 to at least one network and/or other computing device. Network interface 220 may, for example, be coupled to bus 106. By way of example but not limitation, network interface 220 may include a network interface device or card, a modem, a router, a switch, a transceiver, and/or the like.

Computing device 200 may include, for example, at least one input device 230. Input device 230 is representative of one or more mechanisms and/or features that may be configurable to accept user input. Input device 230 may, for example, be coupled to bus 106. By way of example but not limitation, input device 230 may include a keyboard, a keypad, a mouse, a trackball, a touch screen, a microphone, etc., and applicable interface(s).

Computing device 200 may include, for example, at least one display device 240. Display device 240 is representative of one or more mechanisms and/or features for presenting visual information to a user. Display device 240 may, for example, be coupled to bus 106. By way of example but not limitation, display device 240 may include a liquid crystal display (LCD) monitor, a cathode ray tube (CRT) monitor, a projector, and/or the like.

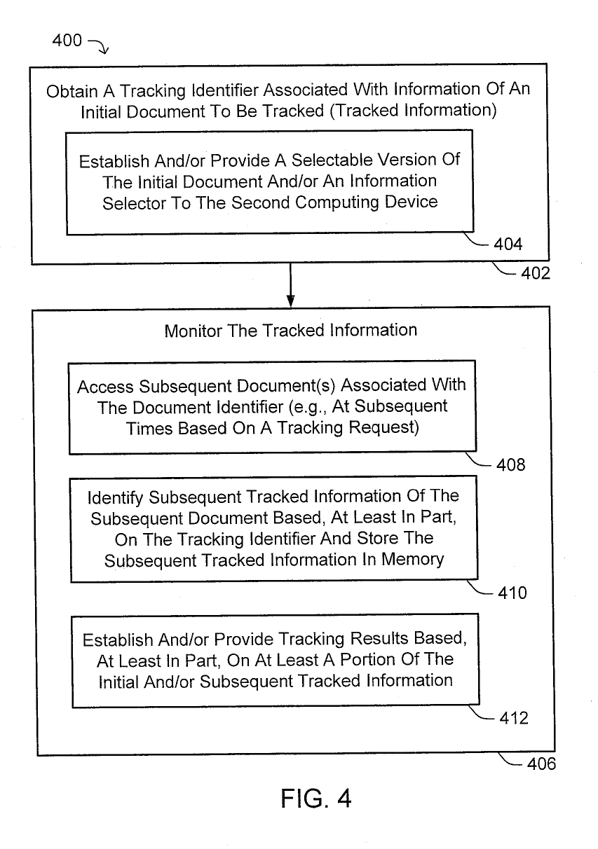

Reference is made next to FIG. 3, which is a block diagram of an example information tracking and monitoring process 300 as represented by certain example functions and/or features associated with a first computing device and a second computing device (e.g., as shown in FIG. 1). It should be understood that this is one example and that all or part of one or more of the functions and/or features may be operatively associated with one or more other computing devices, processing units, etc. It is also recognized that in certain example implementations, one or more computing devices may act as all, part, or both of first and second computing devices.

As illustrated, a first computing device may obtain an initial electronic document 302 from one or more network computing resources 108, for example, based on a network address 301 and/or other like identifier. Network address 301 may, for example, be provided by a second computing device in response to one or more user inputs 303.

In certain instances, initial electronic document 302 may already be formatted so it may serve as a selectable version 302-1. For example, in certain implementations it may be desirable to have at least a portion of selectable version 302-1 be formatted or otherwise configured according to a particular standard or other like format. By way of a non-limiting example, at least a portion of a selectable version of an initial electronic document may be formatted using an extensible markup language (XML), such as, an Extensible Hypertext Markup Language (XHTML) and/or the like. Accordingly, in such example implementations, a tracking identifier 316 may be provided which includes or in some manner relates to at least a portion of an XPath associated the XML.

In certain instances, all or part of initial electronic document 302 may be processed or otherwise altered in some manner with a converter 304 to establish selectable version 302-1. Converter 302 is representative of one or more functions that convert at least a portion of an electronic document from a first format or protocol to a second format or protocol. By way of non-limiting example, converter 304 may reformat an HTML, JavaScript Object Notation (JSON), asynchronous JavaScript XML (AJAX), and/or other formatted electronic document or portion thereof into a desired XML, XHTML, or other like formatted electronic document. Techniques for performing such conversions are well known and beyond the scope of the present description.

Selectable version 302-1 may be provided by the first computing device to the second computing device together and/or separately from an information selector 306. Information selector 306 may include computer-implementable instructions that in response to being executed by one or more processing units in the second computing device enable the second computing device to establish a tracking identifier 316 associated with tracked information 314 of the initial electronic document 302. As illustrated in this example, the second computing device may include a display 308 capable of presenting a graphical user interface (GUI) 310 and/or other like application through which user input(s) 303 may be solicited and/or otherwise received (e.g., via an input device 230 of FIG. 2). GUI 310, in this example, presents visual information 312 associated with selectable version of said initial electronic document 302-1. By way of example but not limitation, visual information 312 may include various types of media, text, graphics, images, and/or other like information associated with initial electronic document 302. Here, in this example, visual information 312 includes tracked information 314.

Information selector 306 may, for example, allow for a user to point (e.g., mouse over) to various selectable portions of visual information 312, including various potential trackable information therein, and select (e.g., mouse click) at least one tracked information 314. In certain example implementations, information selector 306 may comprise script or other like information that provides visual and/or audio feedback to a user. For example, information selector 306 may comprise a Javascript or the like which allows certain portions (e.g., nodes of an electronic document object model (DOM), etc.) to be selectable and in some manner highlighted in response to a mouse over or other like pointer event being detected via a user input device, GUI, etc. Here, for example, cascading style sheets (CSS) and/or the like may be provided for a node to initiate a visible change (e.g., color, highlighting, bolding, etc.) in a portion of visual information 312.

Information selector 306 may, for example, allow for a user to select tracked information and in response establish a tracking identifier 316 associated with tracked information 314. Tracking identifier 316 is representative of information in the form or data and/or instructions which may be used in some manner by a tracking monitor 320 to subsequently attempt to locate and monitor the user selected tracked information in one or more subsequent electronic documents 302-n associated with network address 301 as accessed at times subsequent to the initial time. For example, as mentioned, tracking identifier 316 may comprise Xpath or other like information associated with tracked information 314.

A non-limiting example of an information selector 306 is presented below which may be implemented and/or otherwise adapted to provide or otherwise support highlighting and selection of tracked information 314 via user input(s) 303. In this example “node selector” version, tracked information 314 is associated with a node having numerical information which may be tracked. Here, for example, an Xpath or other like string may be identified by progressing through the DOM or other like structure (e.g., tree structure, etc.) to in an attempt to ascertain a unique identifier (e.g., ID element, etc.) at the selected node itself or at a parent node in the selectable version 302-1, or until a root node of the selected node is ascertained.

```
<script>
if (typeof nodeselector == “undefined”) { nodeselector = { }; }
// Don't let 2 instances run
if (typeof nodeselector.addLibs == “undefined”) {
if (typeof nodeselector.caseSensitive == “undefined”) {
nodeselector.caseSensitive = false; }
nodeselector.addLibs = function ( ) {
  if (typeof(document.body) == “undefined” || document.body ===
    null) {setTimeout(nodeselector.addLibs, 100);
    return;
  }
  var node = document.createElement(“script”);
  node.src = “http://jqueryjs.googlecode.com/files/jquery-1.3.2.min.js”;
  document.body.appendChild(node);
  nodeselector.nodeSelector( );
};
nodeselector.nodeSelector = function ( ) {
  if (typeof($) == “undefined” || $(“*”) === null) {
    setTimeout(nodeselector.nodeSelector, 100);
    return;
  }
  // Incase Firebug isn't installed
  if (window.console === undefined) { window.console =
{log:function( ){ }}; }
  var mouseover = function(ev) {
    ev.stopPropagation( );
    var e = $(ev.target);
    if (typeof e.css(“outline”) != “undefined”) {
      e.data(“saved”, {“outline” : e.css(“outline”)});
      e.css(“outline”, “red solid medium”);
    } else {
      e.data(“saved”, {“backgroundColor”: e.css(“backgroundColor”)});
      e.css(“backgroundColor”, “#0cf”);
    }
  };
  var mouseout = function(ev) {
    ev.stopPropagation( );
    var e = $(ev.target);
    save = e.data(“saved”);
    if (typeof(save) == “undefined”) { return; }
    e.removeData(“saved”);
    for (var i in save) {
      e.css(i, save[i]);
    }
  };
  var click = function (ev) {
    ev.preventDefault( ); ev.stopPropagation( );
    var e = $(ev.target);
    var xpath = getXpath(ev.target);
    console.log(xpath);
    if (typeof(nodeselector.doneURL) != “undefined”) {
      if (nodeselector.doneURL.indexOf(“?”) == −1) {
nodeselector.doneURL += “?”; }
      else { nodeselector.doneURL += “&”; }
      var params = {
        “xpath” : xpath,
        “referer” : window.location.href
      };
      if (typeof nodeselector.params != “undefined”) {
params[‘params’] = nodeselector.params; }
      var url = $.param(params);
      url = nodeselector.doneURL + url;
      console.log(url);
      window.location = url;
      return false;
    }
    var node = $(“#hover”);
    if (node.size( ) === 0) {
      $(document.body).append(“<div id=‘hover’></div>”);
      node = $(“#hover”);
      node
      .css(“position”, “absolute”)
      .css(“display”, “inline”)
      .css(‘border’, ‘1px solid black’)
      .css(“backgroundColor’, ‘white’)
      .css(‘padding’, ‘2px’)
      .css(‘opacity’, ‘.9’)
      .css(‘width’, ‘auto’)
      .css(“zIndex”, 255)
      .click(function(ev) { ev.stopPropagation( ); });
    }
    node.html(xpath);
    node.animate({
      ‘top’ : (e.offset( ).top) + “px”,
      ‘left’: (e.offset( ).left) + “px”
    }, 250);
  };
  $(“*”).each(function( ) {
    $(this)
    .mouseover(mouseover)
    .mouseout(mouseout)
    .click(click);
  });
  var keydown = function(e) {
    if (e.keyCode === undefined && e.charCode !== undefined) {
e.keyCode = e.charCode; }
    // Escape key
    if (e.keyCode == 27) {
      $(“*”).each(function(i) {
        $(this)
        .mouseout( )
        .unbind(“mouseover”, mouseover)
        .unbind(“mouseout”, mouseout)
        .unbind(“click”, click)
        .mouseout( );
      });
      $(“#hover”).remove( );
      $(document).unbind(“keydown”, keydown);
      // Kill the namespace
      delete nodeselector;
    }
  };
  $(document).keydown(keydown);
  function getXpath(e) {
    var xpath = “”;
    var oldE = e;
    while (e.nodeName.toLowerCase( ) != “html”) {
      var node = e.nodeName;
      if (nodeselector.caseSensitive === false) { node =
node.toLowerCase( ); }
      var id = e.id;
      if (id !== undefined && id !== null && id !== “”) {
        xpath = “//” + node + “[@id=‘“ + id + ”’]” + xpath;
        break;
      }
      var parent = e.parentNode;
      var children = $(parent).children(node);
      if (children.size( ) > 1) {
        var good = false;
        children.each(function(i) {
          if (this == e) {
            node = node + “[” + (i+1) + “]”;
            good = true;
            return false;
          }
        });
        if (! good) {
          console.log(“Can't find child, something is wrong with
your dom : ” + node);
          return FALSE;
        }
      }
      xpath = “/” + node + xpath;
      e = parent;
    }
    if (xpath.substring(0, 2) != “//”) { xpath = “/html” + xpath; }
    if (typeof nodeselector.getXpath == “function”) {
      xpath = nodeselector.getXpath(oldE, xpath);
    }
    return xpath;
  }
};
nodeselector.addLibs( );
}
</script>
```

In certain example implementations, in addition to providing tracking identifier 316 to tracking monitor 320 (e.g., of the first computing device), the second computing device may also (optionally) establish a corresponding tracking request 318. For example, in certain implementations tracking request 318 may include information about tracking identifier 316, the second computing device and/or user, desired monitoring options, etc. In certain implementations, information selector 306 may be enabled to establish all or part of tracking request 318 based on user input(s) 303 and/or certain default selections. In certain implementations, a second electronic document (e.g., web page) and/or other like user interactive feature provided to solicit information associated with tracking request 318. By way of non-limiting example, a user may specify a name or other descriptor for the tracked information 314, a user may identify themselves in some manner, a user may specify how subsequent monitoring times, events, etc., a user may specify certain processing features to be applied to tracked information, and/or the other like capabilities.

Tracking identifier 316 and (optional) tracking request 318 may, for example, be provided to a tracking monitor function of the first computing device. Tracking monitor 320 may, for example, access subsequent electronic document(s) 302-n and based, at least in part, on tracking identifier 316, attempt to locate subsequent tracked information 314-z therein. Tracking monitor 320 may perform such monitoring based on certain default monitoring settings and/or based user defined settings provided in tracking request 318. Thus, for example, a tracking request 318 may identify one or more times during which subsequent tracked information 314-z is to be monitored (e.g., accessed, recorded, and/or otherwise processed in some manner).

Tracking results 340 may, for example, include and/or be established based, at least in part, on initial and/or subsequent tracked information. In certain example implementations, (optional) post processing 330 may be employed in some manner to establish certain tracking results. By way of non-limiting example, post processing 330 may include any mathematical, statistical, and/or other like data processing and/or analysis capability. In certain example implementations, post processing may in include a graphing and/or other like data presentation capability. Tracking results 340 may, for example, be provided to one or more computing devices.

While such post processing is illustrated in this example as being provided by the first computing device, it should be understood that (as many of the other functions/features shown herein) that post processing may be performed in whole or part using the second computing device and/or one or more other computing devices, and/or distributed about.

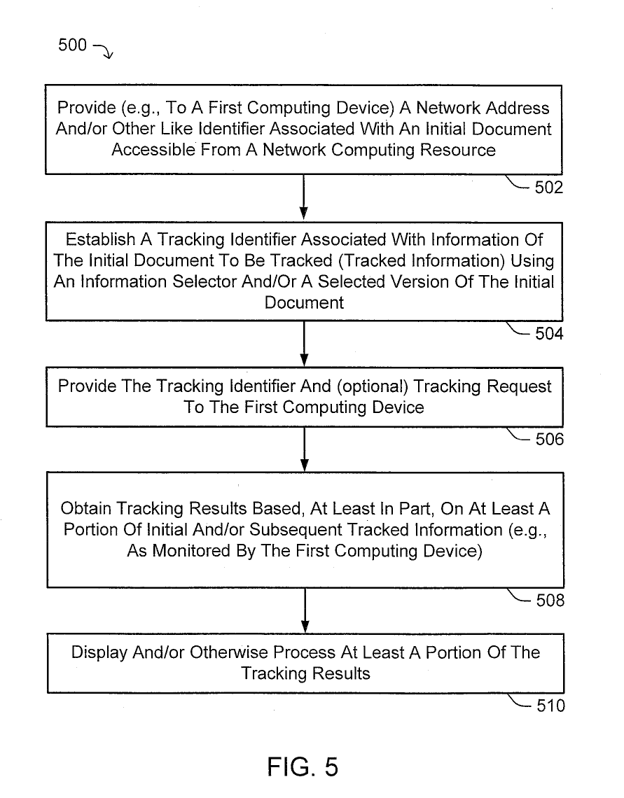

Reference is made next to FIG. 4, which is a flow-diagram illustrating a process 400 that may, for example, be implemented in a first computing device. At block 402, a tracking identifier associated with tracked information may be obtained. For example, at block 404, to obtain a tracking identifier a selectable version of an initial electronic document may be established and/or otherwise provided to a second computing device. Further, for example at block 404, to obtain a tracking identifier an information selector may be established and/or otherwise provided to the second computing device. At block 406, tracked information may be monitored. Here, for example, at block 408 one or more subsequent electronic documents may be accessed, and at block 410 subsequent tracked information may be identified based, at least in part, on the tracking identifier. At block 412, for example, tracking results may be established and/or other provided to one or more computing devices.

Reference is made next to FIG. 5, which is a flow-diagram illustrating a process 500 that may, for example, be implemented in a second computing device. At block 502, a network address and/or other like identifier associated with an initial electronic document accessible from a network computing resource may be provided to a first computing device. At block 504, a tracking identifier associated with tracked information may be established, for example, using an information selector and a selected version of the initial electronic document. At block 506, a tracking identifier and (optional) tracking request may be provided to the first computing device. At block 508, tracking results based, at least in part, on at least a portion of initial and/or subsequent tracked information may be obtained. At block 510, at least a portion of the tracking results may be displayed and/or otherwise processed in some manner.

Thus, as illustrated in the various example implementations and techniques presented herein, in accordance with certain aspects a method may be provided for use as part of a special purpose computing device and/or other like machine that accesses digital signals from memory and processes such digital signals to establish transformed digital signals which may then be stored in memory.

Some portions of the detailed description have been presented in terms of processes and/or symbolic representations of operations on data bits or binary digital signals stored within memory, such as memory within a computing system and/or other like computing device. These process descriptions and/or representations are the techniques used by those of ordinary skill in the data processing arts to convey the substance of their work to others skilled in the art. A process is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining”, “allocating”, “establishing”, “accessing”, and/or the like refer to the actions and/or processes of a computing platform, such as a computer or a similar electronic computing device (including a special purpose computing device), that manipulates and/or transforms data represented as physical electronic and/or magnetic quantities within the computing platform's memories, registers, and/or other information (data) storage device(s), transmission device(s), and/or display device(s).

According to an implementation, one or more portions of an apparatus, such as computing device 200 (FIG. 2), for example, may store binary digital electronic signals representative of information expressed as a particular state of the device, here, computing device 200. For example, an electronic binary digital signal representative of information may be “stored” in a portion of memory 204 by affecting or changing the state of particular memory locations, for example, to represent information as binary digital electronic signals in the form of ones or zeros. As such, in a particular implementation of an apparatus, such a change of state of a portion of a memory within a device, such the state of particular memory locations, for example, to store a binary digital electronic signal representative of information constitutes a transformation of a physical thing, here, for example, memory device 204, to a different state or thing.

While certain exemplary techniques have been described and shown herein using various methods and apparatuses, it should be understood by those skilled in the art that various other modifications may be made, and equivalents may be substituted, without departing from claimed subject matter.

Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising, with a first computing device:
obtaining a tracking identifier as specified via a second computing device, said tracking identifier being associated with tracked information of an initial electronic document associated with a network address as accessed from a network computing resource at an initial time; and
monitoring said tracked information at one or more times subsequent to said initial time by accessing at least one subsequent electronic document associated with said electronic document identifier from said network computing resource, identifying subsequent tracked information of said subsequent electronic document based, at least in part, on said tracking identifier, and storing data representing said subsequent tracked information in memory.

2. The method as recited in claim 1, wherein obtaining said tracking identifier comprises:
providing a selectable version of said initial electronic document to said second computing device; and
providing an information selector to said second computing device, said information selector to establish said tracking identifier based, at least in part, on user input received via a graphical user interface of said second computing device in response to a display of visual information associated with said selectable version of said initial electronic document, wherein said visual information presents said tracked information.

3. The method as recited in claim 2, wherein providing said selectable version of said initial electronic document comprises:
establishing said selectable version of said initial electronic document based, at least in part on said initial electronic document by converting at least a portion of said initial electronic document from a first format to a second format.

4. The method as recited in claim 3, wherein said second format comprises an extensible markup language (XML).

5. The method as recited in claim 3, wherein at least a portion of said selectable version of said initial electronic document is formatted using an extensible markup language (XML), and said tracking identifier comprises at least a portion of an XPath associated with at least said portion.

6. The method as recited in claim 1, wherein monitoring said tracked information further comprises:
selectively identifying said one or more times subsequent to said initial time based, at least in part, on a tracking request as specified via said second computing device.

7. The method as recited in claim 1, further comprising:
providing one or more tracking results based, at least in part, on at least a portion of said subsequent tracked information to at least one other computing device.

8. An apparatus comprising:
memory;
a network interface; and
a processing unit to:
access a tracking identifier as specified via a second computing device and received via said network interface, said tracking identifier being associated with tracked information of an initial electronic document associated with a network address as accessed over a computing network at an initial time; and
monitor said tracked information at one or more times subsequent to said initial time by accessing at least one subsequent electronic document associated with said electronic document identifier from a network computing resource via said network interface, identifying subsequent tracked information of said subsequent electronic document based, at least in part, on said tracking identifier, and providing data representing said subsequent tracked information to said memory for storage therein.

9. The apparatus as recited in claim 8, said processing unit to provide a selectable version of said initial electronic document and an information selector to said second computing device via said network interface, said information selector to establish said tracking identifier based, at least in part, on user input received via a graphical user interface of said second computing device in response to a display of visual information associated with said selectable version of said initial electronic document, wherein said visual information presents said tracked information.

10. The apparatus as recited in claim 9, said processing unit to establish said selectable version of said initial electronic document based, at least in part on said initial electronic document by converting at least a portion of said initial electronic document from a first format to a second format.

11. The apparatus as recited in claim 10, wherein at least a portion of said selectable version of said initial electronic document is formatted using an extensible markup language (XML), and said tracking identifier comprises at least a portion of an XPath associated with at least said portion.

12. The apparatus as recited in claim 8, said processing unit to selectively identify said one or more times subsequent to said initial time based, at least in part, on a tracking request from said second computing device via said network interface.

13. The apparatus as recited in claim 9, said processing unit to establish one or more tracking results based, at least in part, on at least a portion of said subsequent tracked information and provide said one or more one or more tracking results to at least one other computing device via said network interface.

14. An article comprising:
a computer readable medium having computer-implementable instructions stored thereon that are executable by one or more processing units in a first computing device enable said first computing device to:
obtain a tracking identifier as specified via a second computing device, said tracking identifier being associated with tracked information of an initial electronic document associated with a network address as accessed over a computing network at an initial time; and
monitor said tracked information at one or more times subsequent to said initial time by accessing at least one subsequent electronic document associated with said electronic document identifier from a network computing resource via said network interface, identifying subsequent tracked information of said subsequent electronic document based, at least in part, on said tracking identifier, and providing data representing said subsequent tracked information to memory for storage therein.

15. The article as recited in claim 14, wherein said computer-implementable instructions are further executable by said one or more processing units in said first computing device to:
provide a selectable version of said initial electronic document and an information selector to said second computing device said selectable version of said initial electronic document being based, at least in part on said initial electronic document, and
wherein said tracked information selector comprises further computer-implementable instructions that in response to being executed by one or more other processing units in said second computing device enable said second computing device to establish said tracking identifier based, at least in part, on user input received via a graphical user interface of said second computing device in response to a display of visual information associated with said selectable version of said initial electronic document, said visual information presenting said tracked information.

16. The article as recited in claim 15, wherein at least a portion of said selectable version of said initial electronic document is formatted using an extensible markup language (XML), and said tracking identifier comprises at least a portion of an XPath associated with at least said portion.

17. The article as recited in claim 14, said computer-implementable instructions are further executable by said one or more processing units in said first computing device to selectively identify said one or more times subsequent to said initial time based, at least in part, on a tracking request as specified via said second computing device.

18. The article as recited in claim 14, said computer-implementable instructions are further executable by said one or more processing units in said first computing device to establish one or more tracking results based, at least in part, on at least a portion of said subsequent tracked information and provide said tacking results to at least one other computing device.

19. A method comprising, with a computing device:
obtaining a selectable version of an initial electronic document associated with a network address as accessed from a network computing resource at an initial time;
establishing a tracking identifier associated with tracked information of said initial electronic document based, at least in part, on user input received via a graphical user interface in response to a display of visual information associated with said selectable version of said initial electronic document, wherein said visual information presents said tracked information; and
providing said tracking identifier to at least one other computing device.

20. The method as recited in claim 19, further comprising:
providing a tracking request to said at least one other computing device, said tracking request identifying one or more times subsequent to said initial time during which subsequent tracked information is to be monitored and wherein said subsequent tracked information is based, at least in part, on said tracking identifier and associated with at least one subsequent electronic document associated with said electronic document identifier from said network computing resource.
